(19) United States
(12) Patent Application Publication
(10) Pub. No.: US 2025/0123606 A1
(43) Pub. Date: Apr. 17, 2025

(54) SEQUENTIAL DECISION OPTIMIZATION FOR DYNAMIC PROCESSES

(71) Applicant: International Business Machines Corporation, Armonk, NY (US)

(72) Inventors: Dharmashankar Subramanian, Rye Brook, NY (US); Pavankumar Murali, Ardsley, NY (US); Nianjun Zhou, Chappaqua, NY (US)

(21) Appl. No.: 18/486,444

(22) Filed: Oct. 13, 2023

(51) Int. Cl. G05B 13/04; G05B 13/02

(52) U.S. Cl. CPC G05B 13/042; G05B 13/0265; G05B 13/048

(57) ABSTRACT

Techniques are provided for dynamic prediction-based regression optimization. In one embodiment, the techniques involve determining, via a process model, a variable state of the process model, wherein the variable state includes a first input state variable, a first output state variable, and a first control parameter, generating, via a short-term prediction module, a first prediction of a first update of the variable state, generating, via a terminal value prediction module, a second prediction of a second update to the variable state, generating, via a control optimization module, a second control parameter based on the first prediction and the second prediction, and controlling, via a processor, a production process of the process model based on the second control parameter.

### BACKGROUND

The present disclosure relates to the control of production processes, and more specifically, to optimizing and controlling a production process based on predictions of a short-term prediction module and a terminal value prediction module, which is determined based on predictions of a process model corresponding to the production process.

Traditional production process control techniques involve using models to predict future outcomes of production processes. However, the accuracy of the predicted outcomes can decrease as the predictions are made over longer timeframes. A conventional approach to mitigating this issue is to aggregate cascading short-term predictions over shorter timeframes until a final time period is reached. However, aggregating the cascading short-term predictions can compound and amplify the inaccuracies of each short-term prediction over time. In addition, optimizations of process controls using short-term predictions may not accurately reflect optimizations of the process controls using long-term predictions, since the optimizations using the short-term predictions do not account for the results of using the long-term predictions optimizations.

### SUMMARY

A method is provided according to one embodiment of the present disclosure. The method includes determining, via a process model, a variable state of the process model, wherein the variable state includes a first input state variable, a first output state variable, and a first control parameter; generating, via a short-term prediction module, a first prediction of a first update of the variable state; generating, via a terminal value prediction module, a second prediction of a second update to the variable state; generating, via a control optimization module, a second control parameter based on the first prediction and the second prediction; and controlling, via a processor, a production process of the process model based on the second control parameter.

A system is provided according to one embodiment of the present disclosure. The system includes a processor; and memory or storage comprising an algorithm or computer instructions, which when executed by the processor, performs an operation that includes determining, via a process model, a variable state of the process model, wherein the variable state includes a first input state variable, a first output state variable, and a first control parameter; generating, via a short-term prediction module, a first prediction of a first update of the variable state; generating, via a terminal value prediction module, a second prediction of a second update to the variable state; generating, via a control optimization module, a second control parameter based on the first prediction and the second prediction; and controlling, via a processor, a production process of the process model based on the second control parameter.

A computer-readable storage medium having computer-readable program code embodied therewith, the computer-readable program code executable by one or more computer processors to perform an operation, is provided according to one embodiment of the present disclosure. The operation includes determining, via a process model, a variable state of the process model, wherein the variable state includes a first input state variable, a first output state variable, and a first control parameter; generating, via a short-term prediction module, a first prediction of a first update of the variable state; generating, via a terminal value prediction module, a second prediction of a second update to the variable state; generating, via a control optimization module, a second control parameter based on the first prediction and the second prediction; and controlling, via a processor, a production process of the process model based on the second control parameter. dr

### BRIEF DESCRIPTION OF THE DRAWINGS

FIG. 1 illustrates a computing environment, according to one embodiment.

FIG. 2 illustrates a regression optimization module, according to one embodiment.

FIG. 3 illustrates a flowchart of a method of generating short-term and long-term predictions of updates to model variable states, according to one embodiment.

FIG. 4 illustrates a flowchart of a method of controlling a production process based on short-term and long-term predictions of updates to model variable states, according to one embodiment.

### DETAILED DESCRIPTION

Embodiments of the present disclosure improve upon regression optimization of production processes by providing a regression optimization module that optimizes and controls production processes. In one embodiment, the regression optimization module uses a process model that represents a production process, such as manufacturing and industrial processes (e.g., mixing cement, mixing chemicals, manufacturing steel, drilling and processing oil, or the like), that produces products, goods, or materials. The regression optimization module can use machine learning models and statistical regression models to generate short-term and long-term predictions of updates to variable states of the process model. The predictions can be used to generate control parameters, which are used to optimize controls implemented in the production processes.

One benefit of the disclosed embodiments is to improve the optimization of a production process by bounding outputs of the production process over a short-term future timeframe to meet a predicted output over a long-term future timeframe. Further, embodiments of the present disclosure can accurately determine long-term effects of present changes to conditions of the production process.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

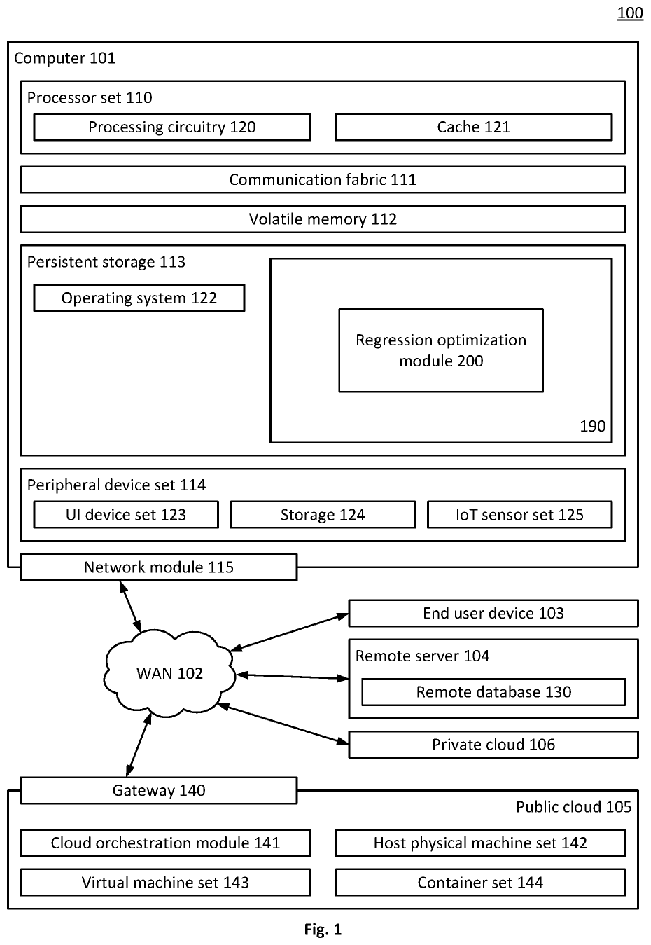

FIG. 1 illustrates a computing environment 100, according to one embodiment. Computing environment 100 contains an example of an environment for the execution of at least some of the computer code involved in performing the inventive methods, such as a new regression optimization module 200, shown in block 190. In addition to block 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

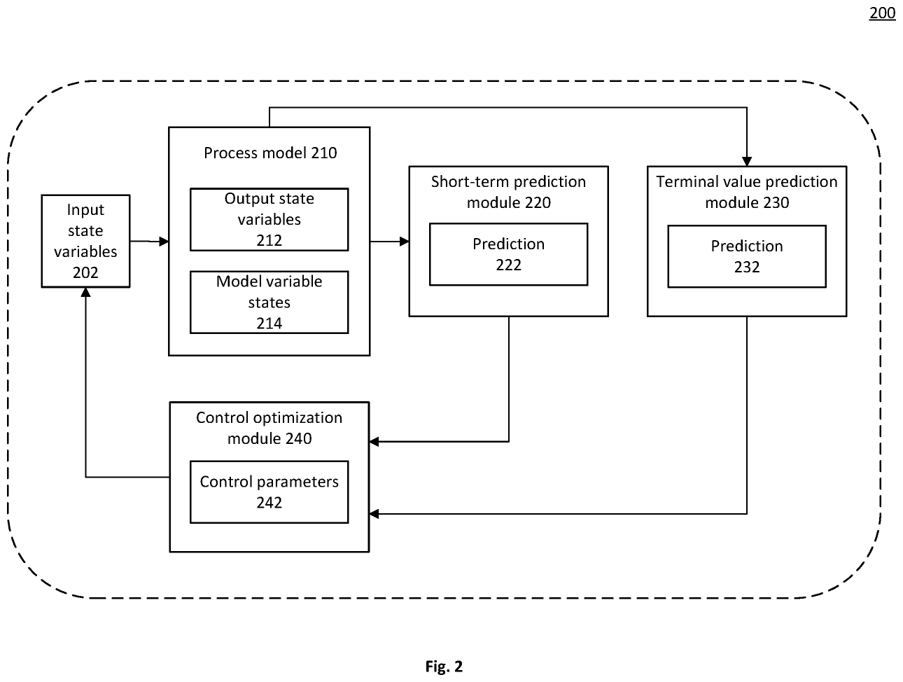

FIG. 2 illustrates a regression optimization module 200, according to one embodiment. As previously discussed, the persistent storage 113 can include the regression optimization module 200. In one embodiment, the regression optimization module 200, and the models and modules included therein, represent one or more algorithms, instruction sets, software applications, or other computer-readable program code that can be executed by the processor set 110 to perform the functions, operations, or processes described herein.

In the illustrated embodiment, the regression optimization module 200 includes the input state variables 202, a process model 210 (which includes output state variables 212 and model variable states 214), a short-term prediction module 220 and a corresponding prediction 222, a terminal value prediction module 230 and a corresponding prediction 232, a control optimization module 240, control parameters 242.

In one embodiment, the process model 210 is a machine learning model trained to learn underlying relationships and dynamics between inputs and outputs of a production process and included operating steps. The production process can represent a manufacturing or industrial process that produces a product, good, material, or the like. For example, the process model may represent processes of mixing cement, mixing chemicals, manufacturing steel, drilling and processing oil, or the like.

The process model 210 can include multiple processing stage models (not shown). In one embodiment, the processing stage models represent operating steps (e.g., process steps, maintenance steps, transformation steps, or the like) of the production process. The operating steps can operate, or abstain from operating, on inputs of the production process, and generate corresponding outputs. The processing stage models can match the operating steps, such that each of the processing stage models receives at least one of the input state variables 202, operates (or abstains from operating) on the input state variables 202, and generates at least one output. In one embodiment, the input state variables 202 represent the controllable inputs of at least one operating step of the production process.

For example, when the production process is a multi-effect evaporator process in a pulp processing plant, a first set of the input state variables 202 can represent a temperature and a flow rate of a liquid being transferred to an evaporator tank. An evaporation process applied to the evaporator tank can be modeled as a processing stage model. An output of the processing stage model can include a concentrated liquid created from the evaporation process. The output may be entered into another operating step of the production process, such as a liquid treatment process in a treatment tank, which can be modeled as another processing stage model.

In one embodiment, the output state variables 212 represent determined or measured outputs of at least one step of the production process. The measured outputs can be determined via various sensors disposed throughout the production process chain. Further, the output state variables 212 can represent controllable or uncontrolled inputs or outputs of a processing stage model. Continuing the previous example, the measured outputs may include a concentration, a temperature, and a flow rate of the concentrated liquid measured at an outlet of the evaporation tank.

In this manner, data determined from inputs, operating steps, and measured outputs of the production process can be used to train the process model 210 (and each processing stage model) to receive input state variables 202 that accurately represent inputs of the production process, and generate output state variables 212 that accurately represent outputs of the production process.

The process model 210 can also generate model variable states 214 that include the input state variables 202, the output state variables 212, or control parameters 242. Each of the model variable states 214 can represent a state of the input state variables 202, the output state variables 212, or the control parameters 242 of the process model 210 at a given time.

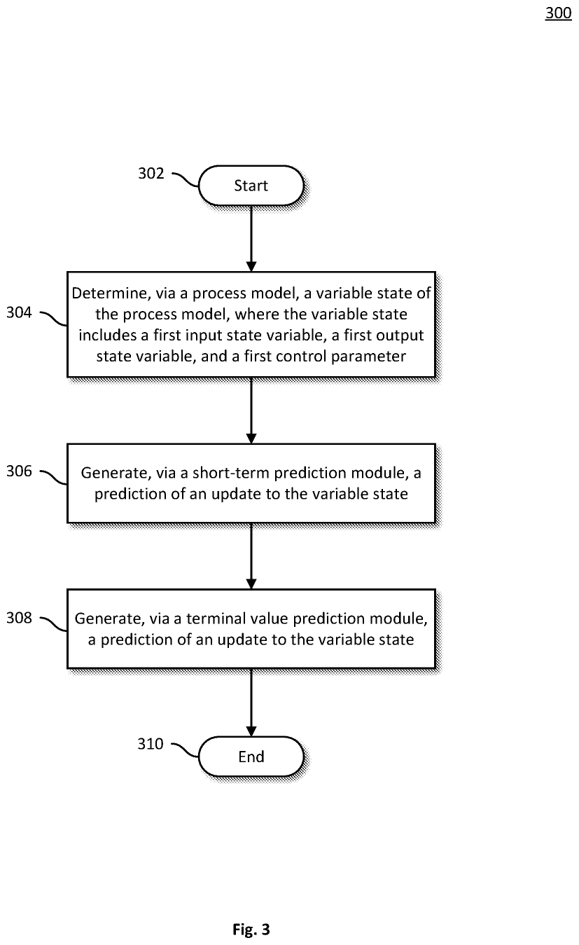

In one embodiment, the short-term prediction module 220 is a machine learning model, or a statistical regression model, that generates a prediction 222 of updates to a variable state of the process model 210. In one embodiment, a prediction can be a reward that represents a resultant benefit or value of a implementing a control parameter to update a model variable state. In one embodiment, a prediction of an update to the model variable state represents an optimized prediction of multiple updates on a short-term future time horizon (e.g., at a time in the near future). The prediction 222 of the short-term prediction module 220 may be referenced as a “short-term prediction or prediction 222” herein. The aforementioned process is described further in FIG. 3.

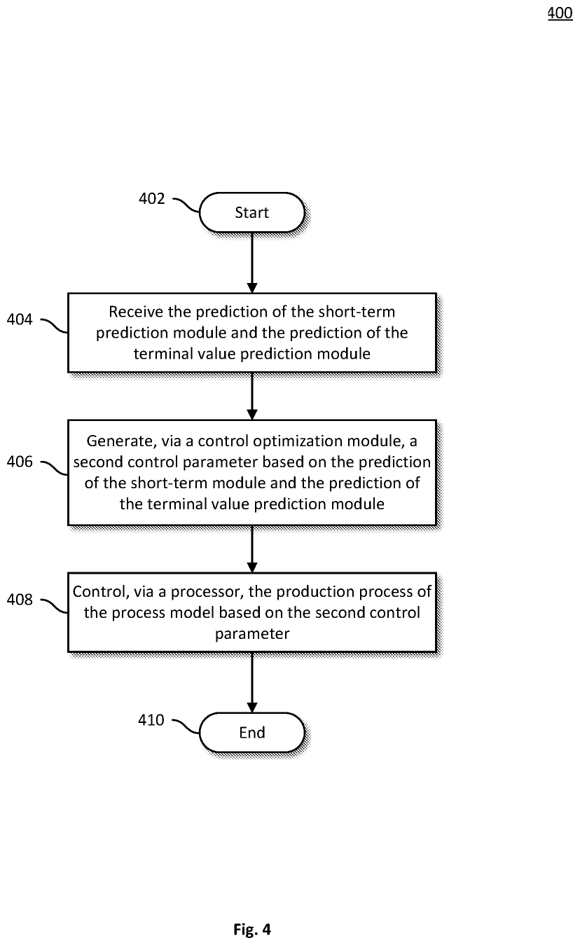

In one embodiment, the terminal value prediction module 230 is a machine learning model that generates a prediction 232 of updates to a variable state of the process model 210 based on historical data. In one embodiment, the prediction 232 represents optimized predictions of variable states on a long-term future time horizon (i.e., at a time after the aforementioned short-term future time horizon). The predictions 232 of the terminal value prediction module 230 may be referenced as “long-term prediction or prediction 232” herein. The aforementioned process is described further in FIG. 4.

The short-term predictions and the long-term predictions can be input into the control optimization module 240, which generates the control parameters 242. In one embodiment, the control optimization module 240 is a Mixed-integer Linear Programming (MILP) model that determines the control parameters 242 by solving models or functions that represent the short-term predictions and the long-term predictions.

In one embodiment, the control parameters 242 represent adjustments (e.g., actions) applied to the input state variables 202, which cause an output of the process model 210 to match, or converge on, an operating point or a value of the short-term predictions or the long-term predictions. Further, the control parameters 242 can represent an optimal set points or operating point (e.g., flow rates, inventory levels, liquid concentrations, sales made or lost, or the like) of the production process.

In one embodiment, the control optimization module 240 directly applies the control parameters 242 to the input state variables 202. In another embodiment, the control optimization module 240 transfers the control parameters 242 to the process model 210, which updates the model variable states 214 (including the input state variables 202). Afterwards, the regression optimization module 200 can control the production process based on the updated variable state.

FIG. 3 illustrates a flowchart of a method 300 of generating short-term and long-term predictions of updates to model variable states, according to one embodiment. In one embodiment, the method 300 is performed by the regression optimization module 200. As previously discussed, the regression optimization module 200 can include the process model 210, the control optimization module 240, the short-term prediction module 220, and the terminal value prediction module 230.

The method 300 begins at block 302. In one embodiment, the regression optimization module 200, via the process model 210, receives an initial input state variable, and determines an initial output state variable. The regression optimization module 200, via the control optimization module 240, then uses the initial output state variable to generate an initial control parameter, which is used to update the initial input state variable to achieve a target output of the process model 210 (e.g., a target output state variable).

At block 304, the regression optimization module 200 determines, via the process model 210, a variable state of the process model 210, where the variable state includes a first input state variable (e.g., the updated initial input state variable), a first output state variable (e.g., the target output state variable), and a first control parameter. As previously discussed, a variable state can represent a state of the process model 210 (i.e., a state of the input state variables 202, the output state variables 212, or the control parameters 242) at a given time. In the embodiment illustrated in FIG. 2, multiple variable states are depicted as model variable states 214.

At block 306, the regression optimization module 200 generates, via the short-term prediction module 220, a prediction 222 of an update of the variable state. In one embodiment, the prediction 222 of the update to the variable state represents a forecast of a model variable state on a short-term future time horizon (e.g., at a time in the near future).

A representation of the update of the model variable states 214 may be as follows: U_{MVS}(t)=ƒᵣ(Sᵢ,ₜ, Sₒ,ₜ, Cₜ), where U_{MVS}(t) is an update of model variable states 214 at time t, fᵣ represents a regression function of the included parameters, S_{i,t} represents a state of input state variable (e.g., controllable variables) at time t, S_{o,t} represents a state of output state variables (e.g., controlled or uncontrolled variables) at time t, and Cₜ represents control parameters at time t.

In one embodiment, the prediction 222 of the update to the model variable states 214 represents an optimized (i.e., minimum or maximum) prediction of the update of the model variable states 214 across the short-term future time horizon. A representation of the prediction 222 of the update to the variable state output from the short-term prediction module 220 may be as follows: P_{STPM}(t)=max/min(Σₜ₌₀^{T1}(γ^{t}*U_{MVS}(t), wherein P_{STPM}(t) represents the prediction 222 of the update to the variable state of the process model 210 at time t, γ^{t} represents a discount factor at time t, and P_{MVS}(t) represents the prediction of a model variable state at time t. In one embodiment, T1 represents an end time of a short-term horizon from time 0 to T1. P_{upd}(t) can be solved via a Mixed-integer Linear Programming (MILP) model (e.g., the control optimization module 240) to determine control parameters used to update the model variable states 214.

In another embodiment, the short-term prediction module 220 is a machine learning model that is trained via a supervised learning process to learn causal relationships between the model variable states 214, and a prediction 222 of updates of model variable states 214 at given times.

At block 308, the regression optimization module 200 generates, via a terminal value prediction module 230, a prediction 232 of an update of the variable state. In one embodiment, a prediction 232 of the update to the variable state represents a forecast of a model variable state on a long-term future time horizon (e.g., at a time after the aforementioned short-term time horizon).

In one embodiment, the terminal value prediction module 230 is a machine learning model trained to receive a model variable state, and output a corresponding prediction 232 of an update of the model variable states 214 at a terminal value of a long-term future time horizon. The terminal value prediction module 230 can be trained using historical data (e.g., inputs, outputs, and measurements of operating steps) of the production process. In one embodiment, the terminal value prediction module 230 uses the historical data of input state variables and output state variables to determine future input state variables and future output state variables over the long-term future time horizon (“future state variables”). The terminal value prediction module 230 can then generate an update (G(t,s)) to the model variable states 214 based on the future state variables, and output a corresponding prediction 232 of the updates at a terminal value of the long-term future time horizon.

In one embodiment, the prediction 232 of the update to the model variable states 214 represents an optimized (i.e., minimum or maximum) prediction of the update of the model variable states 214 across the long-term future time horizon. A representation of the prediction 232 of the update to the variable state may be as follows: P_{TVPM}(t)=max/min(Σ_{t=T1}^{T2}G(t,s)), wherein P_{TVPM}(t) represents the prediction 232 of the update to the variable state of the process model 210 at time t, and G(t,s) represents the update to the model variable states 214 based on the future state variables. In one embodiment, T1 represents the end time of the aforementioned short-term horizon from time 0 to T1, and T2 represents a terminal time at the end of the long-term time horizon. P_{TVPM}(t) can be solved via a Mixed-integer Linear Programming (MILP) model (e.g., the control optimization module 240) to determine control parameters used to update the model variable states 214. The method 300 ends at block 310.

FIG. 4 illustrates a flowchart of a method 400 of controlling a production process based on short-term and long-term predictions of updates to model variable states, according to one embodiment. In one embodiment, the method 400 is performed by the regression optimization module 200. As previously discussed, the regression optimization module 200 can include the process model 210, the control optimization module 240, the short-term prediction module 220, and the terminal value prediction module 230. The method 400 begins at block 402.

At block 404, the regression optimization module 200 receives prediction 222 (P_{STPM}(t)) of the short-term prediction module and the prediction 232 (P_{TVPM}(t)) of the terminal value prediction module. In one embodiment, the control optimization module 240 combines the predictions into a single objective function (e.g., a summation of the predictions together).

At block 406, the regression optimization module 200 generates, via the control optimization module 240, a second control parameter based on the prediction 222 of the short-term prediction module and the prediction 232 of the terminal value prediction module. In one embodiment, the control optimization module 240 is a MILP model that resolves the combination of the predictions (i.e., the single objective function).

At block 408, the regression optimization module 200 controls, via a processor, a production process of the process model based on the second control parameter. In one embodiment, the regression optimization module 200 is communicatively coupled to a control system of the production process in real-time, such that updates to the model variable states 214 of the process model 210 result in updates to the production process.

In another embodiment, the regression optimization module 200 can generate a control signal based on the second control parameter, and transfer the control signal to a control system of the production process, which implements changes to the production process in accordance with the control signal. In yet another embodiment, the regression optimization module 200 operates as a simulation of the production process, and can transmit data of the second control parameter to an operator of the production process to aid in optimizing the production process. The regression optimization module 200 can also generate an alert to notify the operator of an optimizations needed based on the second control parameter variable state.

In this manner, processes of FIGS. 3-4 can be repeated to determine optimized control parameters of given short-term and long-term time horizons on a sliding time window attuned to the production process. The optimized control parameters can be used to control the underlying production process. The method 400 ends at block 410.

While the foregoing is directed to embodiments of the present invention, other and further embodiments of the invention may be devised without departing from the basic scope thereof, and the scope thereof is determined by the claims that follow.

1. A method comprising:
determining, via a process model, a variable state of the process model, wherein the variable state includes a first input state variable, a first output state variable, and a first control parameter;
generating, via a short-term prediction module, a first prediction of a first update of the variable state;
generating, via a terminal value prediction module, a second prediction of a second update to the variable state;
generating, via a control optimization module, a second control parameter based on the first prediction and the second prediction; and
controlling, via a processor, a production process of the process model based on the second control parameter.

2. The method of claim 1, wherein the process model is a machine learning model trained to learn underlying relationships and dynamics of inputs and outputs of the production process;
wherein the first input state variable represents a controllable input of the production process; and
wherein the first output state variable represents a determined output or a measured output of the production process.

3. The method of claim 1, wherein the first input state variable further represents an input of the process model;
wherein the first output state variable further represents an output of one or more processing stages of the process model; and
wherein the first control parameter represents an adjustment to an input state variable.

4. The method of claim 1, wherein the short-term prediction module is a machine learning model or a statistical regression model configured to:
receive the variable state;
generate the first update of the variable state based on the variable state; and
generate the first prediction based on the first update.

5. The method of claim 4, wherein the first prediction represents a minimum or maximum of updated variable states across a first time period, and wherein the first time period ranges from a present time to a first future time period.

6. The method of claim 1, wherein the terminal value prediction module is a machine learning model or a statistical regression model configured to:
receive the variable state;
generate the second update of the variable state based on historical data of input state variables and output state variables of the production process to determine future input state variables and future output state variables; and
generate the second prediction based on the second update.

7. The method of claim 6, wherein the second prediction represents a minimum or a maximum of updated variable states across a second time period, wherein the second time period ranges from a first future time period to a second future time period.

8. A system, comprising:
a processor; and
memory or storage comprising an algorithm or computer instructions, which when executed by the processor, performs an operation comprising:
determining, via a process model, a variable state of the process model, wherein the variable state includes a first input state variable, a first output state variable, and a first control parameter;
generating, via a short-term prediction module, a first prediction of a first update to the variable state;
generating, via a terminal value prediction module, a second prediction of a second update to the variable state;
generating, via a control optimization module, a second control parameter based on the first prediction and the second prediction; and
controlling, via a processor, a production process of the process model based on the second control parameter.

9. The system of claim 8, wherein the process model is a machine learning model trained to learn underlying relationships and dynamics of inputs and outputs of the production process;
wherein the first input state variable represents a controllable input of the production process; and
wherein the first output state variable represents a determined output or a measured output of the production process.

10. The system of claim 8, wherein the first input state variable further represents an input of the process model;
wherein the first output state variable further represents an output of one or more processing stages of the process model; and
wherein the first control parameter represents an adjustment to an input state variable.

11. The system of claim 8, wherein the short-term prediction module is a machine learning model or a statistical regression model configured to:
receive the variable state;
generate the first updated of the variable state based on the variable state; and
generate the first prediction based on the first update.

12. The system of claim 11, wherein the first prediction represents a minimum or maximum of updated variable states across a first time period, and wherein the first time period ranges from a present time to a first future time period.

13. The system of claim 8, wherein the terminal value prediction module is a machine learning model or a statistical regression model configured to:
receive the variable state;
generate the second update of the variable state based on historical data of input state variables and output state variables of the production process to determine future input state variables and future output state variables; and
generate the second prediction based on the second update.

14. The system of claim 13, wherein the second prediction represents a minimum or a maximum of updated variable states across a second time period, wherein the second time period ranges from a first future time period to a second future time period.

15. A computer-readable storage medium having a computer-readable program code embodied therewith, the computer-readable program code executable by one or more computer processors to perform an operation comprising:
determining, via a process model, a variable state of the process model, wherein the variable state includes a first input state variable, a first output state variable, and a first control parameter;
generating, via a short-term prediction module, a first prediction of a first update to the variable state;
generating, via a terminal value prediction module, a second prediction of a second update to the variable state;
generating, via a control optimization module, a second control parameter based on the first prediction and the second prediction; and
controlling, via a processor, a production process of the process model based on the second control parameter.

16. The computer-readable storage medium of claim 15, wherein the process model is a machine learning model trained to learn underlying relationships and dynamics of inputs and outputs of the production process;
wherein the first input state variable represents a controllable input of the production process; and
wherein the first output state variable represents a determined output or a measured output of the production process.

17. The computer-readable storage medium of claim 15, wherein the first input state variable further represents an input of the process model;
wherein the first output state variable further represents an output of one or more processing stages of the process model; and
wherein the first control parameter represents an adjustment to an input state variable.

18. The computer-readable storage medium of claim 15, wherein the short-term prediction module is a machine learning model or a statistical regression model configured to:
receive the variable state;
generate the first update of the variable state based on the variable state; and
generate the first prediction based on the first update.

19. The computer-readable storage medium of claim 18, wherein the first prediction represents a minimum or maximum of updated variable states across a first time period, and wherein the first time period ranges from a present time to a first future time period.

20. The computer-readable storage medium of claim 15, wherein the terminal value prediction module is a machine learning model or a statistical regression model configured to:
receive the variable state;
generate the second update of the variable state based on historical data of input state variables and output state variables of the production process to determine future input state variables and future output state variables; and
generate the second prediction based on the second update, wherein the second prediction represents a minimum or a maximum of updated variable states across a second time period, and wherein the second time period ranges from a first future time period to a second future time period.
